(19) United States
(12) Patent Application Publication
(10) Pub. No.: US 2018/0050712 A1
(43) Pub. Date: Feb. 22, 2018

(54) Wagon and superstructure - Vehicle mounted and transportable

(71) Applicant: Darren Keith Mitchell, Milwaukee, WI (US)

(72) Inventor: Darren Keith Mitchell, Milwaukee, WI (US)

(21) Appl. No.: 15/241,051

(22) Filed: Aug. 18, 2016

(51) Int. Cl. B62B 3/02

(52) U.S. Cl. CPC B62B 3/025; B62B 2206/06; B62B 2206/003

(57) ABSTRACT

An electric mechanical wagon to assist in transportation and hauling various items is disclosed. A removable wagon with a superstructure that can be easily attached to a standard vehicle receiving hitch insert for transportation by said vehicle. The wagon's ease of attachment to the vehicle allows for quick mounting and un-mounting of the wagon to be relocated to a desired location. The mounting and un-mounting of the wagon is facilitated by an electro-mechanical lift system within the wagon itself. This lifting system allows the wagon to raise high enough to be mounted to a receiver plate attached to the vehicle hitch receiver. When mounted the wagon wheels retract and stow into the wagon body allowing enough clearance for transport of the wagon.

### CROSS-REFERENCE TO RELATED APPLICATIONS

| Cited | Filing | Publication | | |
|---|---|---|---|---|
| Patent | date | date | Applicant | Title |
| U.S. Pat. No. 4,199,170 | May 2, | Apr. 22, | Hubner Betty A | Carrier means |
| | 1977 | 1980 | | |
| U.S. Pat. No. 4,593,840 | May 21, | Jun. 10, | Chown Peter A C | Load carrying |
| | 1984 | 1986 | | unit |
| U.S. Pat. No. 4,744,590 | Feb. 13, | May 17, | Chesney Larry J | Removably |
| | 1987 | 1988 | | attachable |
| | | | | suspended |
| | | | | trailer apparatus |
| | | | | and method |
| U.S. Pat. No. 5,108,018 | Feb. 7, | Apr. 28, | James Spinka | Detachable |
| | 1991 | 1992 | | carriers for |
| | | | | motor vehicles |
| U.S. Pat. No. 5,947,357 | Apr. 20, | Sep. 7, | Surkin; Uri | Bicycle rack |
| | 1998 | 1999 | | |
| U.S. Pat. No. 6,237,823 | Feb. 1, | May 29, | Ironwood | Hitch supported |
| | 2000 | 2001 | Pacific, Inc. | carrier for a |
| | | | | vehicle |
| U.S. Pat. No. 6,296,163 | Jun. 28, | Oct. 2, | Kawasaki | Carrier for |
| | 1999 | 2001 | Jukogyo | straddle type |
| | | | Kabushiki | four wheeled all- |
| | | | Kaisha | terrain vehicle |
| | | | | and support |
| | | | | structure |
| | | | | therefor |
| U.S. Pat. No. 6,513,690 | Nov. 27, | Feb. 4, | Michael P. | Supplementary |
| | 2000 | 2003 | Churchill | cargo carrier for |
| | | | | a vehicle |
| U.S. Pat. No. 7,380,803 | Dec. 5, | Jun. 3, | James Paul | Shopping cart |
| | 2005 | 2008 | Thomas | modified for |
| | | | | vehicle transport |
| U.S. Pat. No. 7,905,508 | | Mar. 15, | C2lt | Hitch mounted |
| | | 2011 | | receiver |
| | | | | platform and |
| | | | | complementary |
| | | | | wagon |
| US20020117525 | Feb. 21, | Aug. 29, | Dennis Ahola | Trailer hitch |
| | 2002 | 2002 | | carrier |
| US20040100045 | Nov. 25, | May 27, | Joseph | Convertible |
| | 2002 | 2004 | Amacker | cargo rack |
| US20060118586 | Dec. 4, | Jun. 8, | Ramin Heravi | Vehicular cargo |
| | 2004 | 2006 | | carrier with |
| | | | | adaptable multi- |
| | | | | platforms |
| US20090152314 | Feb. 24, | Jun. 18, | Lee Myrex | Portable hitch |
| | 2009 | 2009 | | mounted cargo |
| | | | | carrier |
| US20090159627 | Oct. 14, | Jun. 25, | Lee Myrex | Portable hitch |
| | 2005 | 2009 | | mounted cargo |
| | | | | carrier |
| U.S. Pat. No. 8,746,377 | May 19, | Jun. 10, | Blue Comet | Electric utility |
| | 2011 | 2014 | Ventures, | cart |
| | | | LLC | |
| US20110057417 | Nov. 11, | Mar. 10, | C2lt | Hitch mounted |
| | 2010 | 2011 | | receiver |
| | | | | platform and |
| | | | | complementary |
| | | | | wagon |

* Cited by examiner

### STATEMENT REGARDING FEDERALLY SPONSORED RESEARCH OR DEVELOPMENT

i. Not Applicable.

### THE NAMES OF THE PARTIES TO A JOINT RESEARCH AGREEMENT

i. Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB

i. N/A

### STATEMENT REGARDING PRIOR DISCLOSURES BY THE INVENTOR OR A JOINT INVENTOR

i. None

### BACKGROUND OF THE INVENTION

i. People often enjoy entertaining outdoors in areas that are not very remote nor difficult to get to but almost never have electricity or running water to support activities associated with a picnic or tail-gating event. Areas such as parks and parking lots are used very frequently by people to have picnics or parties often centered on sporting events, special occasions or just for getting out to of the house. With larger populations and denser urban areas it is frequently more difficult to get areas with adequate seating, close electricity, and any form of running water. Additionally although many of the areas are not far from the primary mode of transportation many are far enough that frequent trips back to the vehicle are required to get all of the supplies and equipment needed for a successful picnic or tailgate event.

ii. Field of the Invention
i. The present invention relates to pull wagons which can be quickly hitched to the rear of a vehicle, and more particularly to a wagon with electro-mechanically raised, lowered, and retracted wheels.
ii. The present invention provides for the wagon structure, wheels, steering capability and a superstructure upon the wagon to allow for the mounting of various equipment and supplies.

### BRIEF SUMMARY

i. An electric mechanical wagon to assist in transportation and hauling various items is disclosed. A removable wagon with a superstructure that can be easily attached to a standard vehicle receiving hitch insert for transportation by said vehicle. The wagon's ease of attachment to the vehicle allows for quick mounting and un-mounting of the wagon to be relocated to a desired location. The mounting and un-mounting of the wagon is facilitated by an electro-mechanical lift system within the wagon itself. This lifting system allows the wagon to raise high enough to be mounted to a receiver plate attached to the vehicle hitch receiver. When mounted the wagon wheels retract and stow into the wagon body allowing enough clearance for transport of the wagon. Description of the wagon and superstructure are described

### BRIEF DESCRIPTION OF THE SEVERAL VIEWS OF THE DRAWING(S)

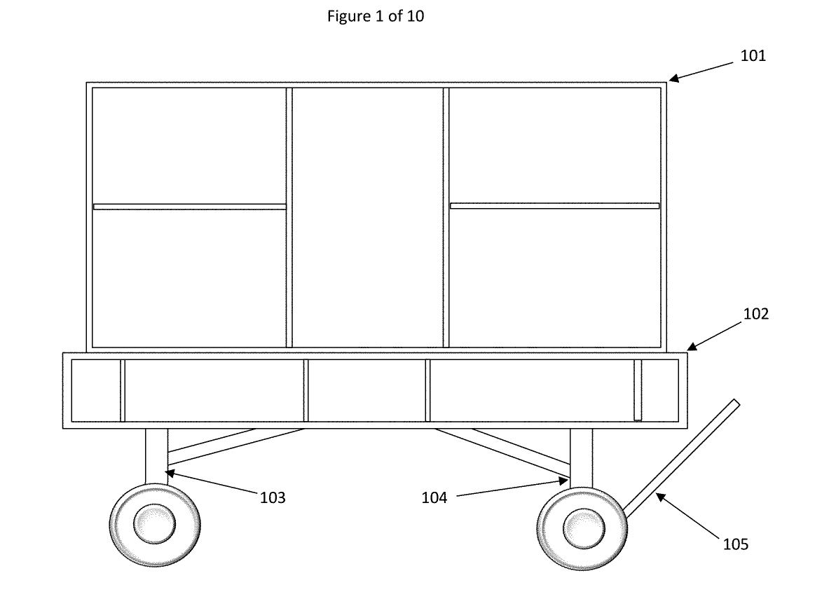

i. FIG. 1 depicts an example of the wagon with the superstructure and wheels in the deployed condition, ready for transport as a wagon from the front view

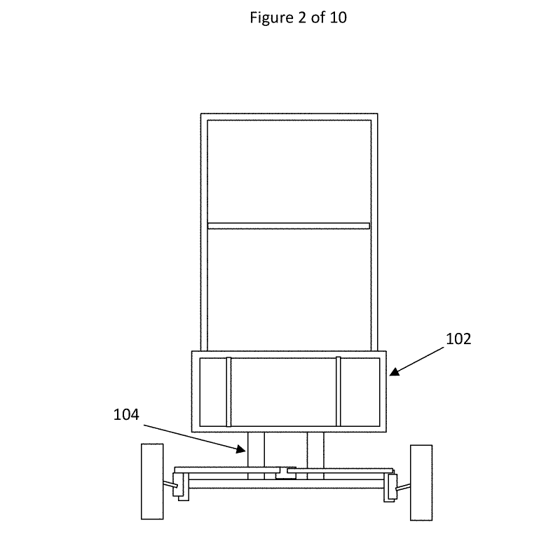

ii. FIG. 2 depicts an example of the wagon with the superstructure and wheels in the deployed condition, ready for transport as a wagon from the side view

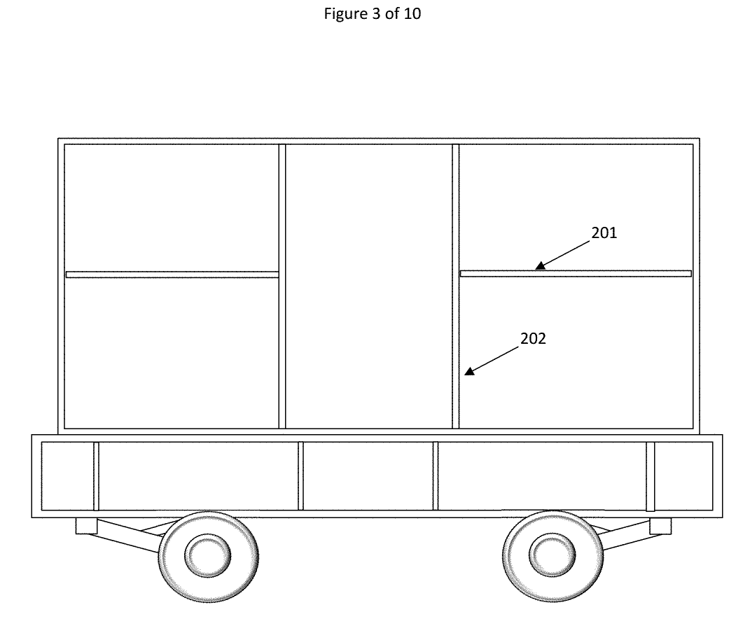

iii. FIG. 3 depicts an example of the wagon with the superstructure and wheels in the stowed condition, as if mounted to a vehicle for transport from the front view

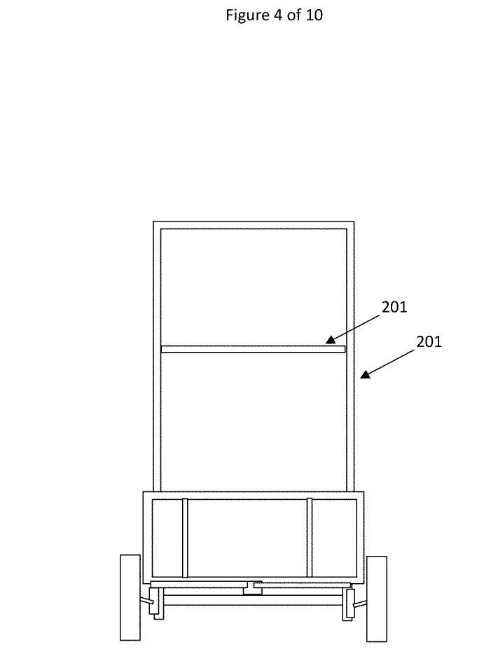

iv. FIG. 4 depicts an example of the wagon with the superstructure and wheels in the stowed condition, as if mounted to a vehicle for transport from the side view

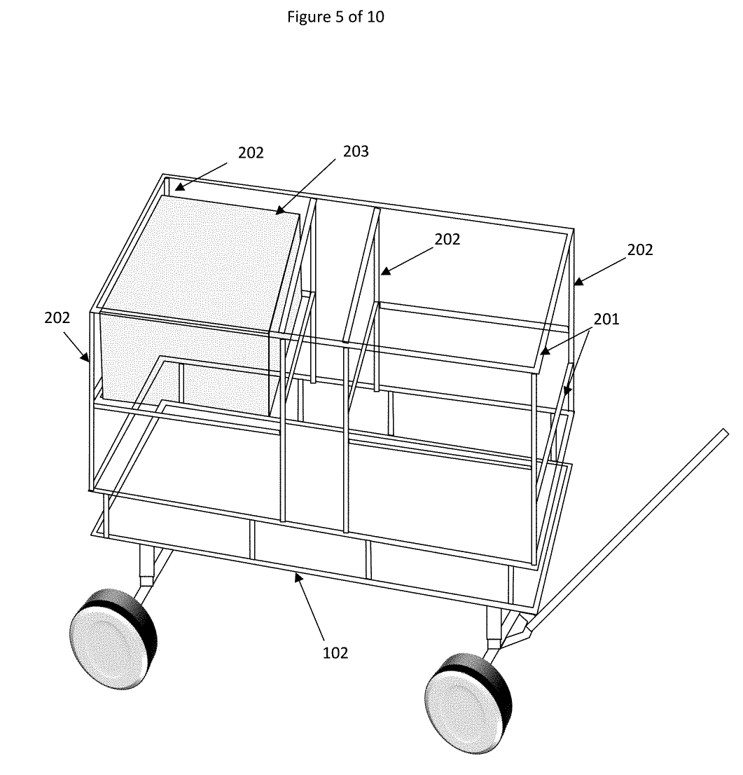

v. FIG. 5 depicts an example of the wagon with superstructure.

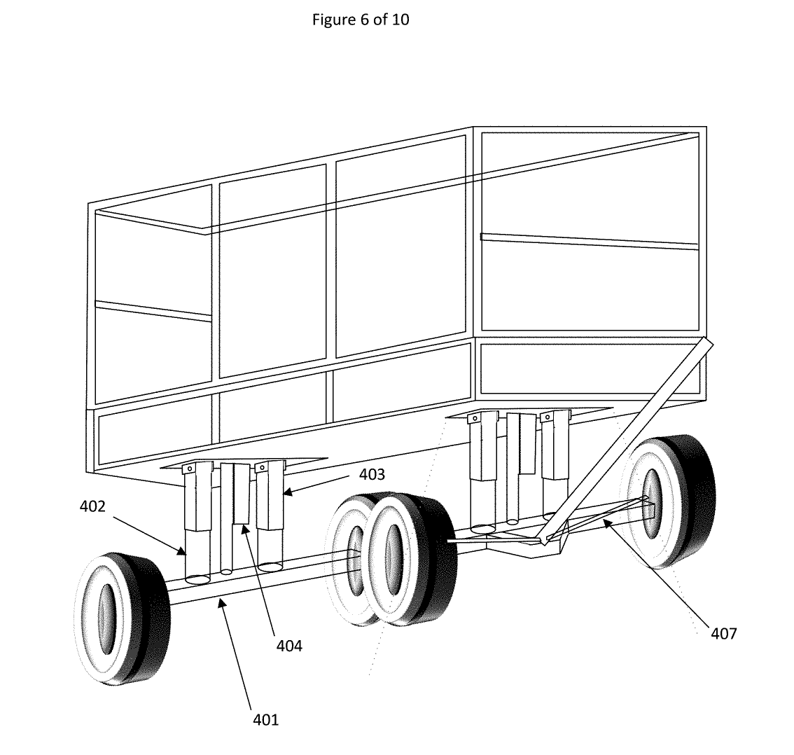

vi. FIG. 6 depicts a closer look at the wheel lift and pivot system used to raise and lower the wagon for mounting then raising the wheels and pivoting for storage.

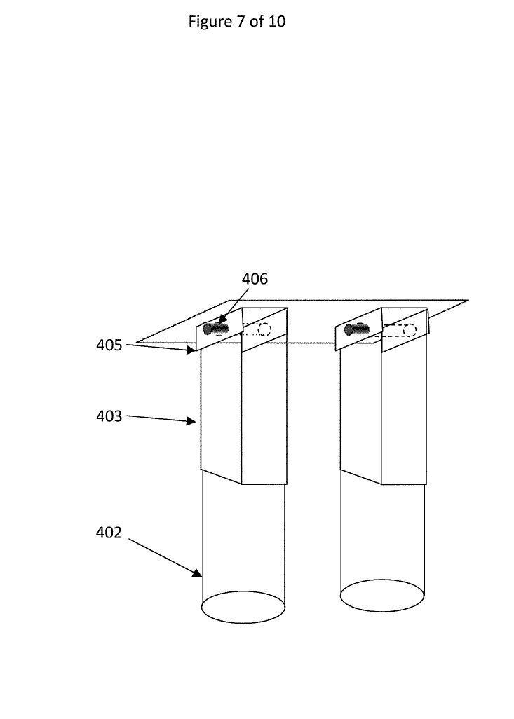

vii. FIG. 7 depicts a closer view of the wheel lift and pivot system

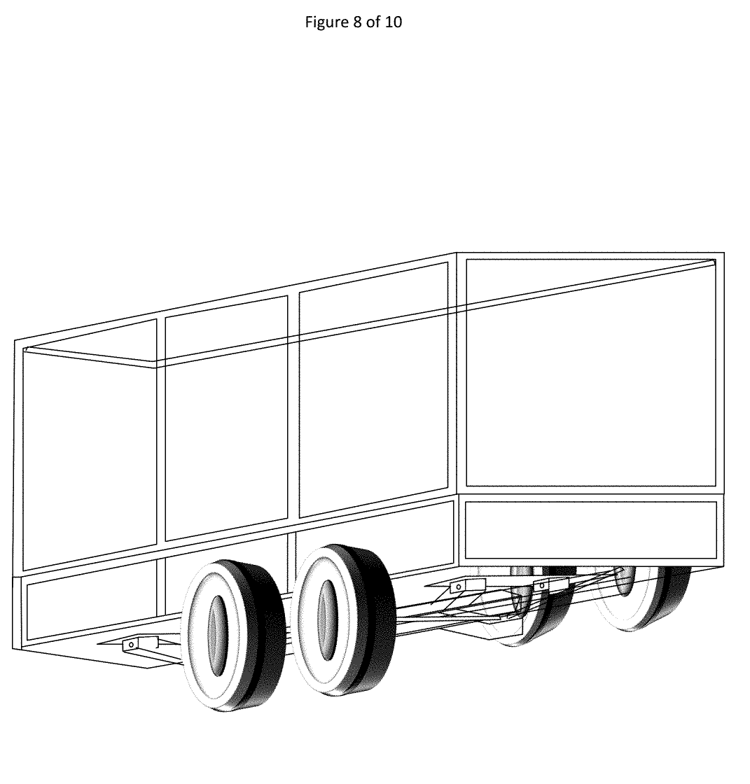

viii. FIG. 8 depicts the wheels in the lifted and stowed position.

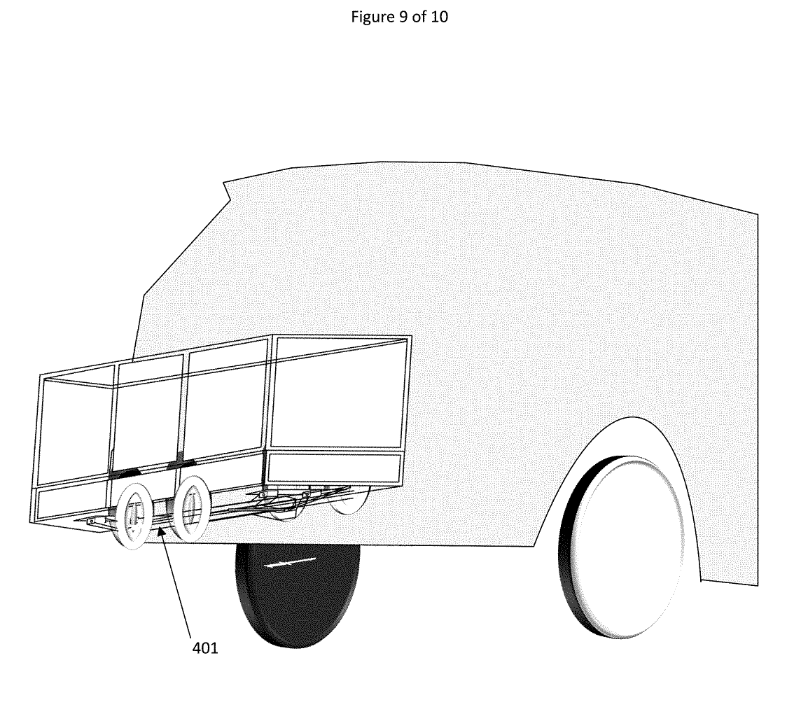

ix. FIG. 9 depicts the wagon with the wheels in the lifted and stowed position as mounted on a vehicle

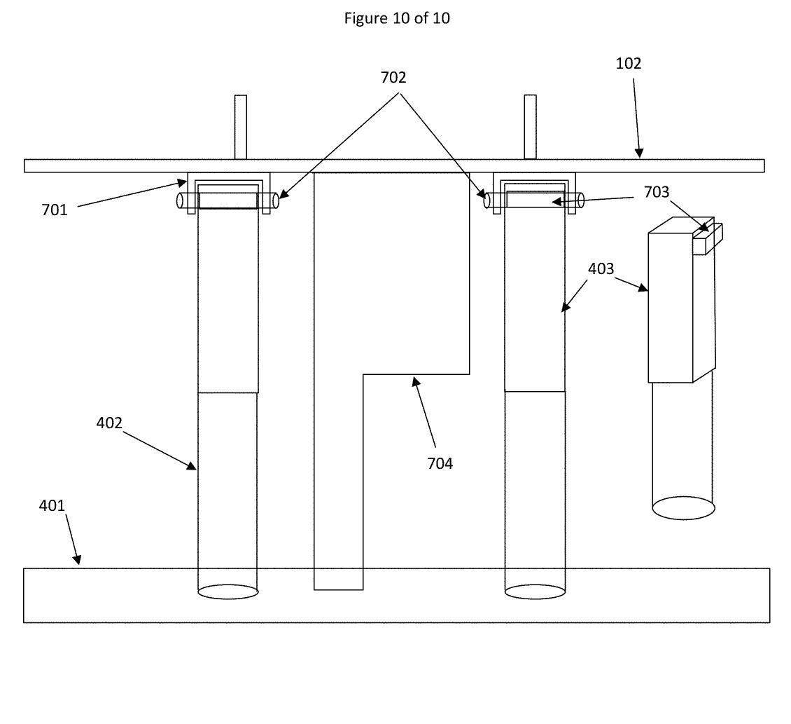

x. FIG. 10 depicts in greater detail the legs used to mount the front and rear wheel axels with the mounting brackets and pivot hinges.

### DETAILED DESCRIPTION OF THE INVENTION

i. Wagons and carriers are known which have a hitch tube shaft on the bottom of the carrier which can be inserted into a receiver style trailer hitch on a vehicle. The receiving mechanisms have no convenient means for lifting and mounting the cargo carrier/wagon onto the hitch. Other cargo carriers are known which also have legs with wheels where the legs can be raised and lowered by hand. Although these types of cargo carriers can be transported on their wheels, they are difficult to raise and lower by hand if they are heavy. Still other cargo carriers are known which also have rotatable legs with wheels which can be rotated up off the ground when the cargo carrier is attached to a vehicle, but the legs are not height-adjustable. In order to overcome some of these limitations, cargo carriers have been constructed with jacks that have wheels so that a cargo carrier with a heavy load can be easily raised and lowered and also be moved from one location to another on its own wheels. However, the jacks with wheels have to be removed from the cargo carrier after it has been hitched to a vehicle. In addition, the jack mechanism in these jacks is exposed to the external environment which can promote fouling and/or corrosion of the jack mechanism.

### 1. SUMMARY

The prior art discloses a number of hitch supported carriers for use primarily on sports utility vehicles to supplement their loading capability.

The following examples and aspects thereof are described and illustrated in conjunction with systems, tools, and methods that are meant to be exemplary and illustrative, not limiting in scope. In various examples, one or more of the above-described problems have been reduced or eliminated, while other examples are directed to other improvements.

This disclosure relates to hitch-based cargo and recreational gear carriers, specifically a removable wagon that can be lifted from a hitch insert & then rolled to a user's preferred destination.

An example is Patent number US 20110057417 which allows individuals to move gear from vehicles to events in one simple step. However this invention continues with the concept of a wagon mounted to a vehicle, where any and all manner of items could be loaded into the wagon for transport. In this invention the equipment being transported is semi-permanently mounted to the wagon and superstructure to allow for a defined set of equipment for transport to meet specific entertainment needs. Moreover in the above mentioned prior art weight could become a significant factor in determining what to load into the wagon.

Another example of prior art is US Patent number US 20090159627, which has legs with an internal screw type jack mechanism to raise and lower the cargo carrier to place the hitch sleeve over the hitch shaft, and to raise the legs so that the vehicle can transport the cargo carrier on the hitch shaft without having to remove the legs. In this case the lifting an lowering of the wagon is comprised of 4 independent lift mechanisms and a steering system composed of four independently moving steering wheels, something not seen in a traditional wagon.

Finally the last example is U.S. Pat. No. 8,746,377, which is an electric cart to assist in transportation and hauling of various items. In this instance the wagon is comprised of 3 wheels where the 2 wheels on the rear axle are powered. This prior art also includes a wagon mounted superstructure to assists in transporting objects however these are removable to meet specific needs.

The objectives of this invention is to overcome existing limitations associated with transporting items by vehicle for specific purposes. Whereas there numerous methods for transporting using a vehicle many of them require loading and unloading of the supplies from the carrier, or the cumbersome mounting and unmounting of the cart or wagon from the vehicle before transport to the desired location.

The overall objective of this invention is to provide a compact comprehensive method to transport event specific or unique items using a wagon hitched to a vehicle then further transported to the final location with no cumbersome loading and unloading or mounting to the vehicle.

It is another objective to overcome the weight limitation associated with mounting a loaded wagon to a vehicle by providing a lifting system within the wagon itself to facilitate the mounting to the vehicle.

### DETAILED DESCRIPTION

While the following description details the preferred embodiments of the present invention, it is to be understood that the invention is not limited in its application to the details of construction and arrangement of the parts illustrated in the accompanying drawings, since the invention is capable of other embodiments and of being practiced in various ways. These drawings are intended to be illustrative of the intent of the invention and are not indicative of final designs or implementations.

The wagon with superstructure of the present invention as shown in FIG. 1. The wagon bottom 102 is constructed as a welded sub-frame assembly. The superstructure 101 is assembled and secured to the wagon sub-frame. Left side 103 and right side 104 each have a set of telescoping wheel axel supports. Each support has a tubular guide keeping the axel and wheels aligned while the wagon is raised or lowered, further explained in another drawing. Each wheel support and leg assembly is secured to the wagon via a U-framed bracket allowing for the collapsing of the leg assemblies to the bottom of the wagon for storage while the wagon is mounted and transported by the vehicle. When the wagon and superstructure assembly is dismounted from the vehicle, it can be pulled and moved as a traditional wagon using the detachable wagon handle 105. The wagon steering mechanism is based on the widely accepted Ackerman steering method.

FIG. 3 shows the wagon and superstructure as a stand-alone wagon with the wagon handle 105 detached. This view displays the superstructure and wagon as if mounted to a vehicle with the wheels in the up and stowed position as viewed from the front. The superstructure can be used to mount all manner of utility items to facilitate different activities. The cross members 201 and risers 202 allow for the mounting of shelves, the storage of containers, and the mounting of equipment such as grills, sinks, and or coolers for use while picnicking as examples.

FIG. 4 shows the wagon and superstructure as a stand-alone wagon with the wagon handle 105 detached. This view displays the superstructure and wagon as if mounted to a vehicle with the wheels in the up and stowed position as viewed from the side.

FIG. 5 depicts the superstructure in greater detail, showing, in perspective, the cross members 201 and the risers 202 which provide the structural support needed for carrying various loads 203 are attached via either a mechanical weld or inserted plastic fittings within the hollow square tubing. This superstructure frame rides within the wagon 102 frame assembly.

FIG. 6 depicts the nature of the wheel and axel mounting system. The axel 401 is permanently connected to hollow tube guides 402 which ride within hollow tube legs 403. This method allows the bottom wagon support to be raised and lowered while keeping the wheel and axel assembly 401 aligned with the support legs 403. The raising and lowering of the wagon assembly is facilitated by an electric actuator 404. The actuator provided the required lifting capability to raise the wagon to the needed height to mount to the transporting vehicle. The leg, axel, and wheels are able to collapse upward toward the middle of the wagon via u-bracket 405 and pin 406 assembly. The front wheel steering system 407 is based on the Ackerman steering method patented in in England in 1818.

FIG. 7 depicts the nature of the wheel and axel mounting system in greater detail. The axel is permanently connected to hollow tube guides 402 which ride 1 hollow tube legs 403. This method allows the bottom wagon support to be raised and lowered while keeping the wheel and axel assembly 401 aligned with the support legs 403.

FIG. 8 shows the same assembly as depicted in FIG. 4 but with the wheel assemblies collapsed and stowed against the undercarriage of the wagon assembly as if mounted to a vehicle for transportation.

FIG. 9 shows the wheel and axle assembly in the stowed position. It shows the front and back leg assemblies 401 as attached to the chassis in the collapsed position for transport. This drawing depicts the wagon after attached to the vehicle and being transported.

FIG. 10 shows the detailed leg assembly with the guide tubes 402 that are mounted to the axle 401. 701 shows the u-bracket as it is attached to the wagon chassis 102. 403 is the square tube that is used to house the axle tube 402. The square tube wheel leg is held to the wagon chassis via a steel pin 702 inserted through the pin guide 703. This enables the leg to rotate up into the retracted position when the wagon is mounted onto the vehicle for transportation. The pin guide is a square tube mounted to the face of the leg assembly 403.

The axle and wheel assemblies are extended by use of an electromechanical actuator. The actuator 704 provides the linear force to raise the wagon for mounting to a vehicle.

Unless the context clearly requires otherwise, throughout the description and the claims, the words “comprise,” “comprising”, and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the disclosure is not intended to be exhaustive or to limit the teachings to the precise form disclosed above. Further any specific numbers noted herein are only examples: alternative implementations may employ differing values or ranges.

The teachings of the disclosure provided herein can be applied to other systems, not of necessarily the system described above. The elements and acts of the various embodiments described above can be combined to provide further embodiments.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further embodiments of the disclosure.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

While certain aspects of the disclosure are presented below in certain claim forms, the inventor contemplates the various aspects of the disclosure in any number of claim forms. For example, while only one aspect of the disclosure is recited as a means-plus-function claim under 35 U.S.C. §112, ¶13, other aspects may likewise be embodied as a means-plus-function claim, or in other forms, such as being embodied in a computer-readable medium. (Any claims intended to be treated under 35 U.S.C. §112, ¶13 will begin with the words “means for”.) Accordingly, the applicant reserves the right to add additional claims after filing the application to pursue such additional claim forms for other aspects of the disclosure.

It will be understood that various changes in the details, materials, and arrangements of the parts which has been described and illustrated above in order to explain the nature of this invention may be made by those skilled in the art without departing from the principle and scope of the invention as recited in the following claims.

What is claimed is:

1. A removable attachable suspended frame and superstructure comprising:
(a) a frame;
(b) a plurality of parallel horizontal and vertical strength members connected to said frame;
(d) means of connecting said frame with receiving adaptor and means for removing suspended said frame from said frame receiving means;
(e) a duality of supports rotatable and attached to the underside of said frame for supporting said suspended wagon upon the removal of said interconnecting means from said receiving means;
(f) means for raising and retracting said supports in a lifted position when said frame is attached to a towing vehicle and for lowering and locking said supports in an extended position when said frame is standing alone;
(g) wheel means attached to said support so that when said supports are locked in said extended position and said frame is standing alone, said frame may be rolled from one place to another;
(h) a structural means for use in mounting and transporting materials on said frame

2. A method for providing a removably attachable suspended trailer comprising the steps of:
(a) constructing a frame;
(b) mounting a plurality of vertical and horizontal strength members on said frame;
(d) providing a means interconnecting said frame and said frame receiving means for removably suspending said frame from said frame receiving means;
(e) providing a means for rotating the attached plurality of legs to the underside of said frame for supporting said suspended trailer upon the removal of said interconnecting means from said frame receiving means;
(f) providing a locking means for locking said legs in a retracted position when said frame is attached to said towing vehicle and for locking said legs in an extended position when said frame is standing alone;
(g) attaching wheel means to said legs so that when said legs are locked in said extended position and said frame is standing alone, said frame may be rolled from one place to another;
